(19) United States
(12) Patent Application Publication
(10) Pub. No.: US 2020/0407024 A1
(43) Pub. Date: Dec. 31, 2020

(54) Shock Absorbing Mount Assembly

(71) Applicant: Lee Harper, Leesburg, GA (US)

(72) Inventor: Lee Harper, Leesburg, GA (US)

(21) Appl. No.: 16/454,682

(22) Filed: Jun. 27, 2019

(51) Int. Cl. B63B 29/04; F16F 15/02

(52) U.S. Cl. CPC B63B 29/04; B63B 2029/043; F16F 15/02

(57) ABSTRACT

A shock absorbing mount assembly for enhancing comfort for a person sitting in a nautical vehicle includes a first panel that is coupled to a seat post in a nautical vehicle. A plurality of shock absorbers is each coupled to the first panel. A second panel is coupled to each of the shock absorbers. Thus, the second panel is urgeable toward the first panel when the shock absorbers are compressed. A seat is coupled to the second panel. Thus, the shock absorbers can absorb shock from waves over which the nautical vehicle is travelling for enhancing comfort for the user.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to shock absorbing assemblies and more particularly pertains to a new shock absorbing assembly for enhancing comfort for a user sitting in a nautical vehicle.

### BRIEF SUMMARY OF THE INVENTION

An embodiment of the disclosure meets the needs presented above by generally comprising a first panel that is coupled to a seat post in a nautical vehicle. A plurality of shock absorbers is each coupled to the first panel. A second panel is coupled to each of the shock absorbers. Thus, the second panel is urgeable toward the first panel when the shock absorbers are compressed. A seat is coupled to the second panel. Thus, the shock absorbers can absorb shock from waves over which the nautical vehicle is travelling for enhancing comfort for the user.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a shock absorbing mount assembly according to an embodiment of the disclosure.

FIG. 2 is an exploded perspective view of an embodiment of the disclosure.

FIG. 3 is an exploded in-use view of an embodiment of the disclosure.

FIG. 4 is a top perspective in-use view of an embodiment of the disclosure.

FIG. 5 is a perspective in-use view of an embodiment of the disclosure.

### DETAILED DESCRIPTION OF THE INVENTION

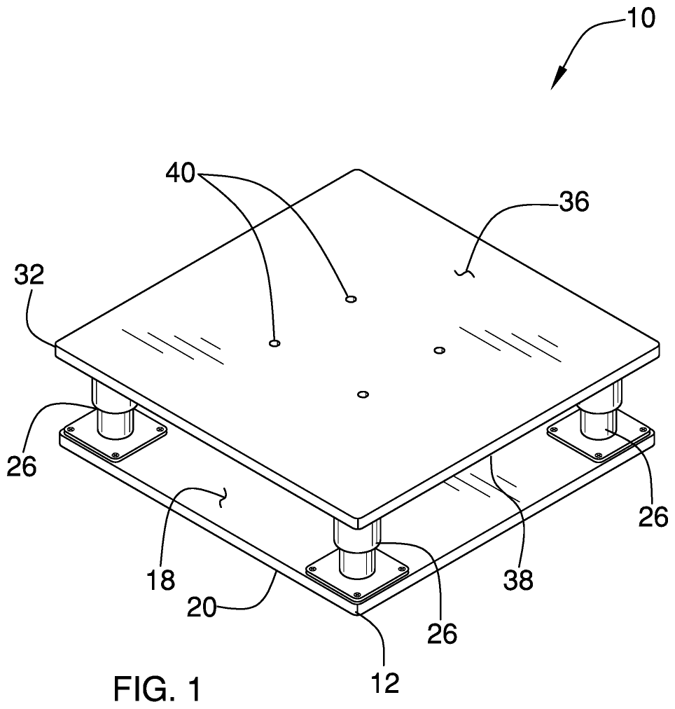

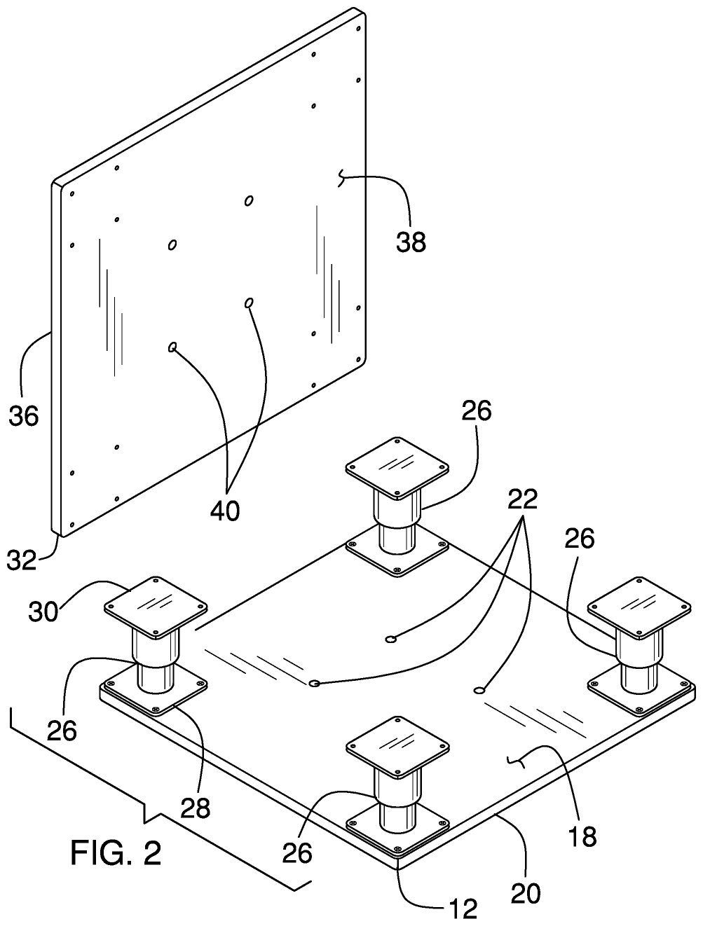

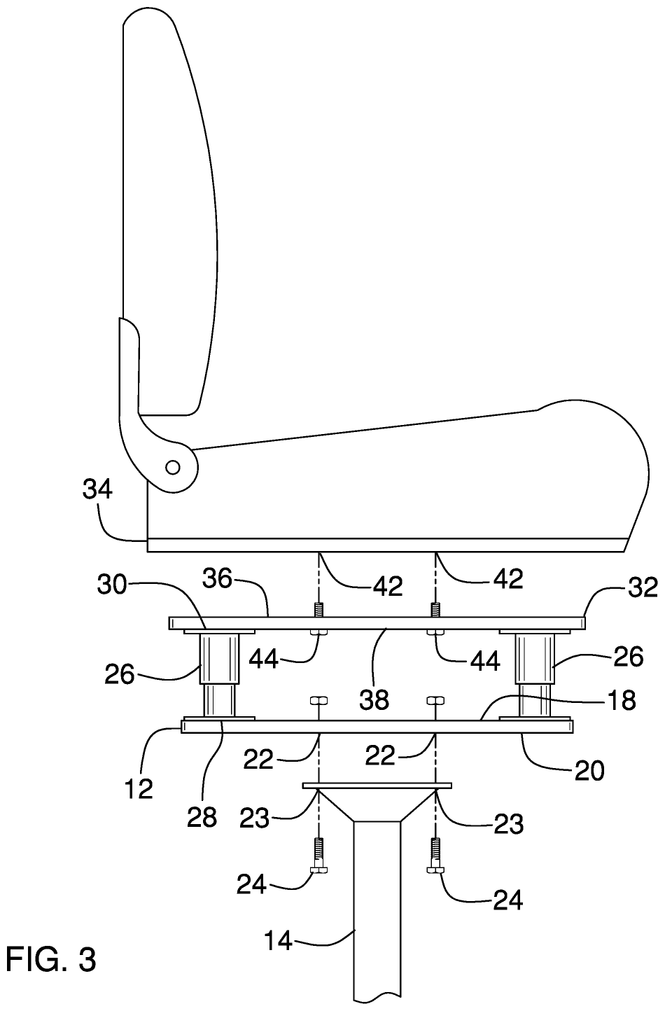

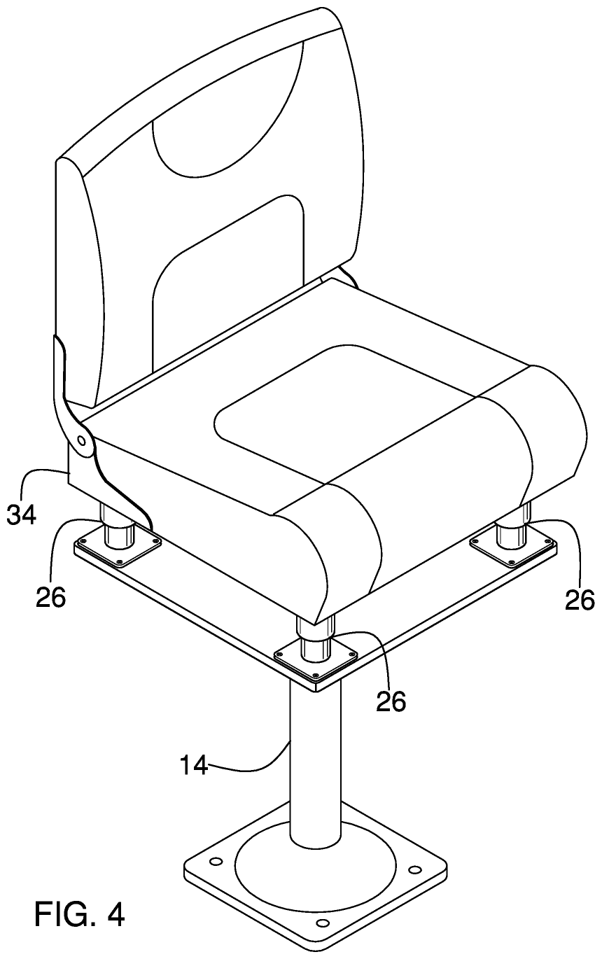

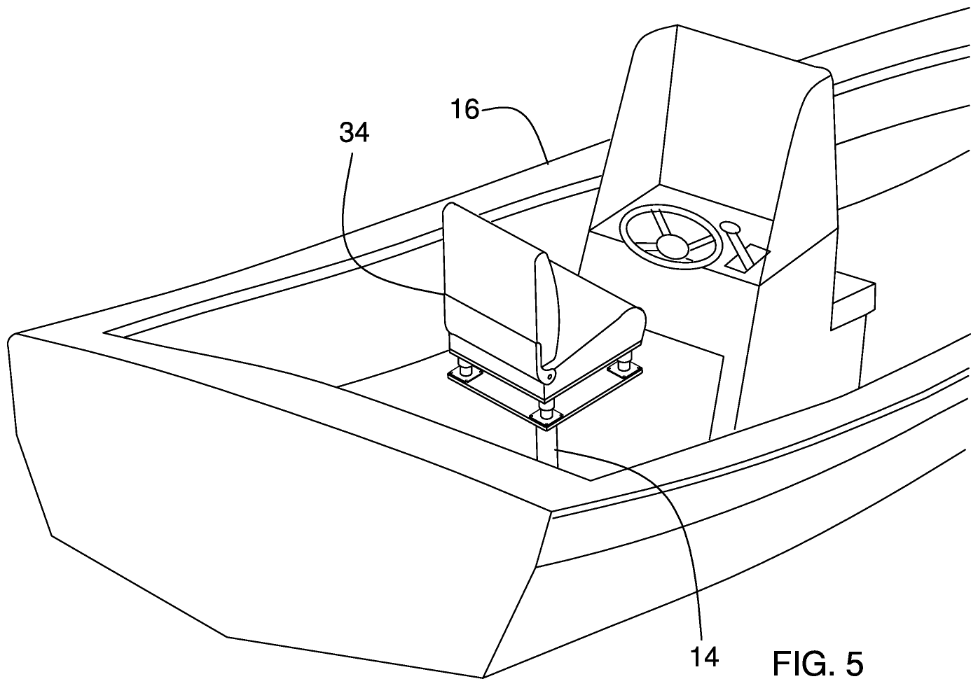

With reference now to the drawings, and in particular to FIGS. 1 through 5 thereof, a new shock absorbing assembly embodying the principles and concepts of an embodiment of the disclosure and generally designated by the reference numeral 10 will be described.

As best illustrated in FIGS. 1 through 5, the shock absorbing mount assembly 10 generally comprises a first panel 12 that is coupled to a seat post 14 in a nautical vehicle 16. The nautical vehicle 16 may be a fishing boat, a ski boat, a pontoon boat or any other type of boat. The first panel 12 has a bottom surface 18 and a top surface 20, and the first panel 12 has a plurality of fastener apertures 22 each extending through the top surface 20 and the bottom surface 18. The fastener apertures 22 are spaced apart from each other and are distributed around a center of the first panel 12. Each of the fastener apertures 22 is positioned at strategic locations on the first panel 12 thereby facilitating each of the fastener apertures 22 to be aligned with a respective one of a plurality of connection points 23 on the seat post 14. The first panel 12 may have a length and a width of approximately 14.0 inches.

A plurality of post fasteners 24 is provided and each of the post fasteners 24 extends through a respective one of the fastener apertures 22 and engages a respective one of the connection points 23 on the seat post 14. In this way the first panel 12 is coupled to the seat post 14. Each of the post fasteners 24 may comprise a nut and bolt, a screw or any other type of releasable fastener.

A plurality of shock absorbers 26 is provided and each of the shock absorbers 26 is coupled to the first panel 12. Each of the shock absorbers 26 has a first end 28 and a second end 30. Moreover, each of the shock absorbers 26 is resiliently compressible between the first end 28 and the second end 30. The first end 28 of each of the shock absorbers 26 is coupled to the top surface 20 of the first panel 12. Additionally, each of the shock absorbers 26 is positioned adjacent to a respective one of four corners of the first panel 12. Each of the shock absorbers 26 may comprise a compressed gas shock absorber, an air bag inflated to a selected pressure, a resiliently compressible member or any other type of shock absorber that has a threshold weight which corresponds to the average weight of a human being.

A second panel 32 is provided and the second panel 32 is coupled to each of the shock absorbers 26. The second panel 32 is urgeable toward the first panel 12 when the shock absorbers 26 are compressed. A seat 34 is coupled to the second panel 32. In this way the shock absorbers 26 absorb shock from waves over which the nautical vehicle 16 is travelling for enhancing comfort for the user. Thus, the shock absorbers 26 protect the user's lower back from impact energy while the user is seated in the seat 34.

The second panel 32 has an upper surface 36 and a lower surface 38, and a plurality of fastener apertures 40 each extends through the upper surface 36 and the lower surface 38. Each of the fastener apertures 40 in the second panel 32 is positioned at strategic locations corresponding to connection points 42 on a frame of the seat 34. The second end 30 of each of the shock absorbers 26 is coupled to the lower surface 38 of the second panel 32. Thus, the second panel 32 is spaced from the first panel 12. The second panel 32 may have a length and a width of approximately 14.0 inches.

A plurality of seat fasteners 44 is provided and each of the seat fasteners 44 is extendable through a respective one of the fastener apertures 40 in the second panel 32. Each of the seat fasteners 44 engages the respective connection point 42 on the frame of the seat 34. In this way the seat 34 is coupled to the second panel 32. Each of the seat fasteners 44 may comprise a nut and a bolt, a screw or any other type of releasable fastener.

In use, the first panel 12 is coupled to the seat post 14 and the seat 34 is coupled to the second panel 32. In this way the shock absorbers 26 cushion the seat 34 when the user sits in the seat 34. Moreover, the shock absorbers 26 absorb impact energy when the nautical vehicle 16 is travelling or when the nautical vehicle 16 is rolling over waves. Thus, the shock absorbers 26 protect the user's lower back from impact energy while the user is sitting in the seat 34.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A shock absorbing mount assembly being configured to movably support a chair in a nautical vessel thereby enhancing comfort for a user, said assembly comprising:
a first panel being coupled to a seat post in a nautical vehicle;
a plurality of shock absorbers, each of said shock absorbers being coupled to said first panel; and
a second panel being coupled to each of said shock absorbers, said second panel being urgeable toward said first panel when said shock absorbers are compressed, said second panel having a seat being coupled thereto wherein said shock absorbers are configured to absorb shock from waves over which the nautical vehicle is travelling for enhancing comfort for the user.

2. The assembly according to claim 1, wherein said first panel has a bottom surface and a top surface, said first panel having a plurality of fastener apertures each extending through said top surface and said bottom surface, said fastener apertures spaced apart from each other and being distributed around a center of said first panel, each of said fastener apertures being positioned at strategic locations on said first panel thereby facilitating each of said fastener apertures to be aligned with a respective one of a plurality of connection points on the seat post.

3. The assembly according to claim 2, further comprising a plurality of post fasteners, each of said post fasteners extending through a respective one of said fastener apertures and engaging a respective one of said connection points on the seat post to couple said first panel to the seat post.

4. The assembly according to claim 2, wherein each of said shock absorbers has a first end and a second end, each of said shock absorbers being resiliently compressible between said first end and said second end, said first end of each of said shock absorbers being coupled to said top surface of said first panel, each of said shock absorbers being positioned adjacent to a respective one of four corners of said first panel.

5. The assembly according to claim 4, wherein said second panel has an upper surface and a lower surface, said second panel having a plurality of fastener apertures each extending through said upper surface and said lower surface, each of said apertures in said second panel being positioned at strategic locations corresponding to connection points on a frame of the seat, said lower surface having said second end of each of said shock absorbers being coupled thereto such that said second panel is spaced from said first panel.

6. The assembly according to claim 5, further comprising a plurality of second fasteners, each of said second fasteners being extendable through a respective one of said apertures in said second panel to engage a respective connection point on the frame of the seat.

7. A shock absorbing mount assembly being configured to movably support a chair in a nautical vessel thereby enhancing comfort for a user, said assembly comprising:
a first panel being coupled to a seat post in a nautical vehicle, said first panel having a bottom surface and a top surface, said first panel having a plurality of fastener apertures each extending through said top surface and said bottom surface, said fastener apertures spaced apart from each other and being distributed around a center of said first panel, each of said fastener apertures being positioned at strategic locations on said first panel thereby facilitating each of said fastener apertures to be aligned with a respective one of a plurality of connection points on the seat post;
a plurality of post fasteners, each of said post fasteners extending through a respective one of said fastener apertures and engaging a respective one of said connection points on the seat post to couple said first panel to the seat post;
a plurality of shock absorbers, each of said shock absorbers being coupled to said first panel, each of said shock absorbers having a first end and a second end, each of said shock absorbers being resiliently compressible between said first end and said second end, said first end of each of said shock absorbers being coupled to said top surface of said first panel, each of said shock absorbers being positioned adjacent to a respective one of four corners of said first panel;
a second panel being coupled to each of said shock absorbers, said second panel being urgeable toward said first panel when said shock absorbers are compressed, said second panel having a seat being coupled thereto wherein said shock absorbers are configured to absorb shock from waves over which the nautical vehicle is travelling for enhancing comfort for the user, said second panel having an upper surface and a lower surface, said second panel having a plurality of fastener apertures each extending through said upper surface and said lower surface, each of said apertures in said second panel being positioned at strategic locations corresponding to connection points on a frame of the seat, said lower surface having said second end of each of said shock absorbers being coupled thereto such that said second panel is spaced from said first panel; and
a plurality of seat fasteners, each of said seat fasteners being extendable through a respective one of said apertures in said second panel to engage a respective connection point on the frame of the seat.
